(19) United States
(12) Patent Application Publication
(10) Pub. No.: US 2025/0271561 A1
(43) Pub. Date: Aug. 28, 2025

(54) METHOD FOR ATTENUATING EFFECTS OF GALVANOMETER ANGLE MEASUREMENT NOISE IN SCANNER POINT CLOUD

(71) Applicant: Lumentum Operations LLC, San Jose, CA (US)

(72) Inventor: Andrew James TELFORD, Ottawa (CA)

(21) Appl. No.: 18/749,822

(22) Filed: Jun. 21, 2024

Related U.S. Application Data
(60) Provisional application No. 63/558,960, filed on Feb. 28, 2024.

(51) Int. Cl. G01S 7/497; G01S 17/894

(52) U.S. Cl. CPC G01S 7/497; G01S 17/894

(57) ABSTRACT

A beam scanning method includes generating a first driving signal based on a first angle setpoint; generating a second driving signal based on a second angle setpoint; driving a two-dimensional scanner about a first scanning axis based on the first driving signal and about a second scanning axis based on the second driving signal; generating a distance measurement based on a reflected light beam; generating a first estimated angle measurement signal based on the first angle setpoint and a dynamic model of the two-dimensional scanner; generating a second estimated angle measurement signal based on the second angle setpoint and the dynamic model of the two-dimensional scanner; associating the distance measurement with a first estimated angle value corresponding to the first estimated angle measurement signal; and associating the distance measurement with a second estimated angle value corresponding to the second estimated angle measurement signal.

### CROSS-REFERENCE TO RELATED APPLICATION

This patent application claims priority to U.S. Patent Application No. 63/558,960, filed on Feb. 28, 2024, and entitled “METHOD FOR ATTENUATING EFFECTS OF GALVANOMETER ANGLE MEASUREMENT NOISE IN SCANNER POINT CLOUD.” The disclosure of the prior application is considered part of and is incorporated by reference into this patent application.

### TECHNICAL FIELD

The present disclosure relates generally to beam scanning systems and methods for beam scanning.

### BACKGROUND

A scanning system may use two-dimensional (2D) or three-dimensional (3D) scanning to scan one or more light beams within a field-of-view (FOV) according to a scanning pattern. The scanning system may use two scanning axes, including a first scanning axis that is configured to steer the one or more light beams in a first direction at a first scanning frequency and a second scanning axis that is configured to steer the one or more light beams in a second direction at a second scanning frequency. The second scanning axis is typically perpendicular to the first scanning axis. Transmitted light beams may be reflected back to the scanning system from one or more objects in the FOV as reflected light beams. A 3D image of a scanned scene or a scanned object can then be generated based on distance measurements corresponding to the transmitted/reflected light beams. Additionally, or alternatively, the reflected light beams may be used by the scanning system to detect objects within the FOV for further processing.

### SUMMARY

In some implementations, a beam scanning system includes a two-dimensional scanner comprising a first galvanometer scanner configured to rotate about a first scanning axis based on a first driving signal, and a second galvanometer scanner configured to rotate about a second scanning axis based on a second driving signal; a time-of-flight sensor configured to receive a reflected light beam and generate a distance measurement based on the reflected light beam; a driver system configured to receive a first angle setpoint for the first galvanometer scanner and a second angle setpoint for the second galvanometer scanner, drive the first galvanometer scanner with the first driving signal based on the first angle setpoint, and drive the second galvanometer scanner with the second driving signal based on the second angle setpoint; and a system controller configured with a dynamic model of the two-dimensional scanner, wherein the system controller is configured to generate a first estimated angle measurement signal based on the first angle setpoint and the dynamic model, wherein the first estimated angle measurement signal follows a first angular trajectory of the first galvanometer scanner about the first scanning axis, wherein the system controller is configured to generate a second estimated angle measurement signal based on the second angle setpoint and the dynamic model, wherein the second estimated angle measurement signal follows a second angular trajectory of the second galvanometer scanner about the second scanning axis, and wherein the system controller is configured to associate the distance measurement with a first estimated angle value corresponding to the first estimated angle measurement signal, associate the distance measurement with a second estimated angle value corresponding to the second estimated angle measurement signal, and generate a point in a three-dimensional point cloud based on the distance measurement, the first estimated angle value, and the second estimated angle value.

In some implementations, a beam scanning system includes a two-dimensional scanner comprising a galvanometer scanner configured to rotate about a first scanning axis based on a first driving signal, and rotate about a second scanning axis based on a second driving signal; a time-of-flight sensor configured to receive a reflected light beam and generate a distance measurement based on the reflected light beam; a driver system configured to receive an angle vector setpoint corresponding to a two-dimensional scanning coordinate, drive the galvanometer scanner about the first scanning axis with the first driving signal based on the angle vector setpoint, and drive the galvanometer scanner about the second scanning axis with the second driving signal based on the angle vector setpoint; and a system controller configured with a dynamic model of the two-dimensional scanner, wherein the system controller is configured to generate a first estimated angle measurement signal based on the angle vector setpoint and the dynamic model, wherein the first estimated angle measurement signal follows a first angular trajectory of the galvanometer scanner about the first scanning axis, wherein the system controller is configured to generate a second estimated angle measurement signal based on the angle vector setpoint and the dynamic model, wherein the second estimated angle measurement signal follows a second angular trajectory of the galvanometer scanner about the second scanning axis, and wherein the system controller is configured to associate the distance measurement with a first estimated angle value corresponding to the first estimated angle measurement signal, associate the distance measurement with a second estimated angle value corresponding to the second estimated angle measurement signal, and generate a point in a three-dimensional point cloud based on the distance measurement, the first estimated angle value, and the second estimated angle value.

In some implementations, a beam scanning method includes generating a first driving signal based on a first angle setpoint; generating a second driving signal based on a second angle setpoint; driving a two-dimensional scanner about a first scanning axis based on the first driving signal and about a second scanning axis based on the second driving signal; generating a distance measurement based on a reflected light beam; generating a first estimated angle measurement signal based on the first angle setpoint and a dynamic model of the two-dimensional scanner, wherein the first estimated angle measurement signal follows a first angular trajectory about the first scanning axis; generating a second estimated angle measurement signal based on the second angle setpoint and the dynamic model of the two-dimensional scanner, wherein the second estimated angle measurement signal follows a second angular trajectory about the second scanning axis; associating the distance measurement with a first estimated angle value corresponding to the first estimated angle measurement signal; associating the distance measurement with a second estimated angle value corresponding to the second estimated angle measurement signal; and generating a point in a three-dimensional point cloud based on the distance measurement, the first estimated angle value, and the second estimated angle value.

### BRIEF DESCRIPTION OF THE DRAWINGS

FIG. 1A is a schematic block diagram of a 2D scanning system according to one or more implementations.

FIG. 1B is a schematic block diagram of a 2D scanning system according to one or more implementations.

FIG. 2 shows a control loop of a beam scanning system according to one or more implementations.

FIG. 3 shows a modeling system according to one or more implementations.

FIG. 4 shows a system according to one or more implementations.

FIG. 5 shows a system according to one or more implementations.

FIG. 6 is a flowchart of an example process associated with a beam scanning method.

### DETAILED DESCRIPTION

The following detailed description of example implementations refers to the accompanying drawings. The same reference numbers in different drawings may identify the same or similar elements.

In 3D sensing and imaging technologies, such as light detection and ranging (LIDAR), a scan can be performed to illuminate an area referred to as a field-of-view. For example, a scanning mirror may be arranged to receive transmitted light beams from a light transmitter and steer (scan) the transmitted light beams into the field-of-view to perform a scanning of the environment. The transmitted light beams may be backscattered by one or more objects back toward the scanning system as reflected light beams where the reflected light beams are detected by a sensor. For example, the sensor may be a photodetector array. The sensor may convert each reflected light beam into an electrical signal (e.g., a current signal or a voltage signal) that may be further processed by the scanning system to generate object data or an image, such as a point cloud. While light may be scanned in two dimensions, a third dimension (e.g., a depth dimension) may be obtained from distance measurements. The distance measurements may be performed based on a time-of-flight of transmitted and reflected light beams. 2D scanning coordinates along with distance information may be used to generate a point cloud of a scanned environment.

A single scanning mirror with two scanning axes may be used for a scanning operation to perform a two-dimensional scan. Alternatively, two scanning mirrors, each with a single scanning axis, may be used for a scanning operation to perform the two-dimensional scan. For example, the scanning axes of the two scanning mirrors may be arranged orthogonal to each other such that one scanning mirror scans in a x-direction and the other scanning mirror scans in a y-direction. Thus, the two scanning mirrors are used in combination to direct a laser beam in a two-dimensional scanning pattern, such as a raster pattern, to scan the field-of-view. The laser beam may be reflected off an object and the returned reflected beam is analyzed to determine the time-of-flight which provides a third measurement dimension (e.g., a distance measurement to the object). The system may measure the mirror angle of each scanning mirror, and the measured mirror angles of the two scanning mirrors may be combined with the distance measurement. These three measurements may be processed into a final 3D point cloud. However, if the mirror angle measurements are corrupted by noise, the final point cloud will be degraded and less accurate, which may negatively affect object detection and/or may require more complex signal processing that requires higher processing bandwidth and/or power. In some cases, the noise may render the final point cloud unusable.

Some implementations provide a beam scanning system with a galvanometer-based two-dimensional scanner and a method for attenuating an angle measurement noise without attenuating an angle signal. The galvanometer-based two-dimensional scanner may include a single galvanometer scanner (e.g., a single scanning mirror) with two scanning axes, or may include two galvanometer scanners (e.g., two scanning mirrors), each with a single scanning axis. A galvanometer scanner may have a rapidly moving angle has a high frequency spectral content. As a result, an angle measurement cannot simply be low-pass filtered to remove broadband measurement noise, as this would also remove important information from an angle measurement signal, resulting in point cloud inaccuracy. Instead, one or more implementations may use a dynamic model of the galvanometer-based two-dimensional scanner to remove the angle measurement noise in order to provide more accurate angle measurements. As a result, the beam scanning system may generate a more accurate 3D point cloud based on the angle measurements.

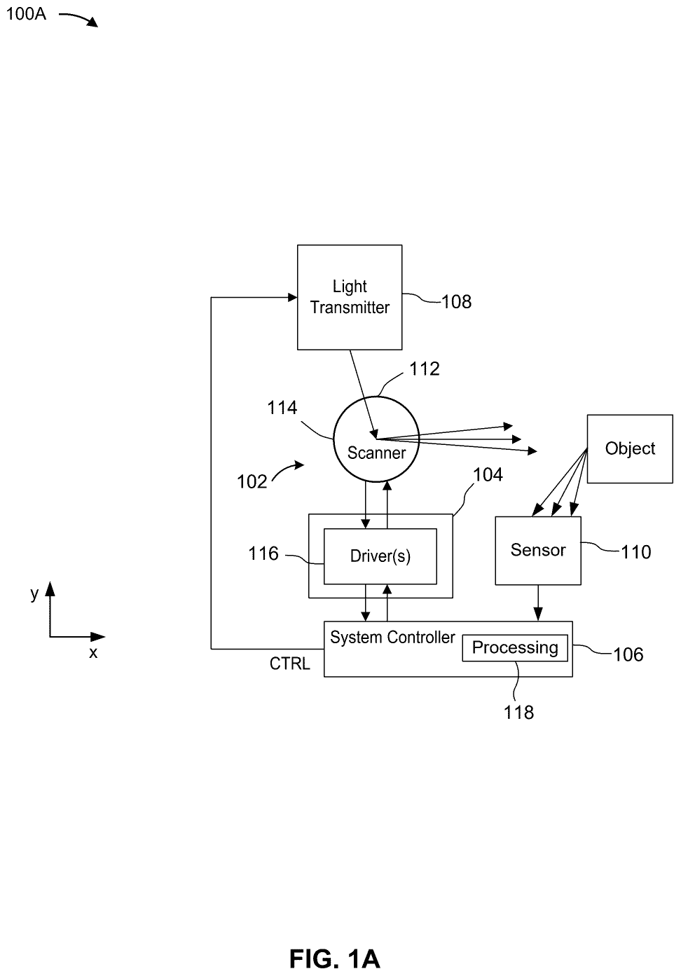

FIG. 1A is a schematic block diagram of a 2D scanning system 100A according to one or more implementations. In particular, the 2D scanning system 100A includes a scanner 102 configured to steer or otherwise deflect light beams according to a 2D scanning pattern for scanning 3D objects. The 2D scanning system 100A further includes a driver system 104, a system controller 106, and a light transmitter 108, and a sensor 110.

In the example shown in FIG. 1A, the scanner 102 may be a mechanical moving mirror and may be configured to rotate or oscillate via rotation about two scanning axes that are typically orthogonal to each other. For example, the two scanning axes may include a first scanning axis 112 that enables the scanner 102 to steer light in a first scanning direction (e.g., an x-direction) and a second scanning axis 114 (e.g., an inner scanning axis) that enables the scanner 102 to steer light in a second scanning direction (e.g., a y-direction). As a result, the scanner 102 can direct light beams in two dimensions according to the 2D scanning pattern.

A scan can be performed to illuminate an area referred to as a field-of-view. The scan, such as an oscillating horizontal scan (e.g., from left to right and right to left of a field-of-view), an oscillating vertical scan (e.g., from bottom to top and top to bottom of a field-of-view), or a combination thereof (e.g., a Lissajous scan or a raster scan) can illuminate the field-of-view in a continuous scan fashion. In some implementations, the 2D scanning system 100A may be configured to transmit successive light beams (e.g., as successive light pulses) in different scanning directions to scan the field-of-view. The scanner 102 can direct a transmitted light beam at a desired 2D measurement coordinate (e.g., an x-y coordinate) in the field-of-view, controlled by the system controller 106.

In some implementations, the scanner 102 may be arranged to receive transmitted light beams from the light transmitter 108 and steer (scan) the transmitted light beams into the field-of-view to perform a scanning of the environment. The transmitted light beams may be backscattered by one or more objects back toward the 2D scanning system 100A as reflected light beams, where the reflected light beams are detected by the sensor 110. For example, the sensor 110 may be a photodetector array. The sensor 110 may convert each reflected light beam into an electrical signal (e.g., a current signal or a voltage signal) that may be further processed by the 2D scanning system 100A to generate object data or an image. Thus, the sensor 110 may be a time-of-flight sensor configured to receive a reflected light beam and generate one or more distance measurements based on the reflected light beam. In such implementations, the desired 2D measurement coordinate may correspond to a particular transmission direction in the field-of-view that is targeted by the transmitted light beam for object detection or scanning, with different 2D measurement coordinates corresponding to different transmission directions. The system controller 106 may receive electrical signals from the sensor and perform signal processing on the electrical signals for object feature detection.

Accordingly, multiple light beams transmitted at different transmission times can be steered by the scanner 102 at the different 2D measurement coordinates of the field-of-view in accordance with the 2D scanning pattern. The scanner 102 can be used to scan the field-of-view in both scanning directions by changing an angle of deflection of the scanner 102 on each of the first scanning axis 112 and the second scanning axis 114.

The driver system 104 may be configured to generate driving signals (e.g., actuation signals) to drive the scanner 102 about the first scanning axis 112 and the second scanning axis 114. In particular, the driver system 104 may be configured to apply the driving signals to an actuator structure of the scanner 102. In some implementations, the driver system 104 includes a driver 116 configured to drive the scanner 102 about the first scanning axis 112 and the second scanning axis 114. The scanner 102 may have separate actuator structures for each scanning axis. Thus, the scanner 102 may have a first actuator structure for the first scanning axis 112, and a second actuator structure for the second scanning axis 114. The driver 116 may apply a first driving signal to the first actuator structure to drive the scanner 102 about the first scanning axis, and may apply a second driving signal to the second actuator structure to drive the scanner 102 about the second scanning axis. In some implementations, the driver 116 may include separate drivers for each scanning axis 112 and 114. In implementations in which the scanner 102 is used as an oscillator, the driver 116 may be configured to drive an oscillation of the scanner 102 about the first scanning axis 112 at a first frequency, and drive an oscillation of the scanner 102 about the second scanning axis 114 at a second frequency.

The driver 116 may be configured to receive feedback information from the scanner 102, such as rotational position information (e.g., an angle measurement). The system controller 106 may use the rotational position information to trigger light beams at the light transmitter 108. For example, the system controller 106 may use the rotational position information to set a transmission time of light transmitter 108 in order to target a particular 2D measurement coordinate of the 2D scanning pattern.

In some implementations, the system controller 106 is configured to set a driving frequency of the scanner 102 for each scanning axis and is capable of synchronizing the oscillations about the first scanning axis 112 and the second scanning axis 114. In particular, the system controller 106 may be configured to control an actuation of the scanner 102 about each scanning axis by controlling the driving signals. The system controller 106 may control the frequency, the phase, the duty cycle, and/or a voltage level of the driving signals to control the actuations about the first scanning axis 112 and the second scanning axis 114. The actuation of the scanner 102 about a particular scanning axis controls its range of motion and scanning rate about that particular scanning axis.

The light transmitter 108 may include one or more light sources, such as one or more laser diodes or one or more light emitting diodes, for generating one or more light beams. In some implementations, the light transmitter 108 may be configured to sequentially transmit a plurality of light beams (e.g., light pulses) as the scanner 102 changes its transmission direction in order to target different 2D measurement coordinates. The plurality of light beams may include visible light, infrared (IR) light, or other types of illumination signals, depending on an application of the 2D scanning system 100A. A transmission sequence of the plurality of light beams and a timing thereof may be implemented by the light transmitter 108 according to a control signal CTRL received from the system controller 106.

The system controller 106 may be configured to control components of the 2D scanning system 100A. In certain applications, the system controller 106 may also be configured to receive programming information with respect to the 2D scanning pattern and control a timing of the plurality of light beams generated by the light transmitter 108 based on the programming information. Thus, the system controller 106 may include both processing and control circuitry that is configured to generate control signals for controlling the light transmitter 108 and the driver 116. For example, the system controller 106 may include processing circuitry 118 configured to execute machine instructions, and, based on executing the machine instructions, generate control signals for controlling the 2D scanning system 100A to perform a 2D scan of the scanning area according to the 2D scanning pattern. Thus, the processing circuitry may include one or more processors and other signal processing components. In some implementations, the processing circuitry 118 may include a DSP. The processing circuitry 118, in conjunction with control circuitry, may control the light transmitter 108 and the scanner 102 to target each 2D measurement coordinate with a respective light beam. The processing circuitry 118 may control the scanner 102 by controlling one or more parameters of the driver 116, such as the frequency, the phase, the duty cycle, and/or a voltage level of the driving signals used for driving each scanning axis 112 and 114. The processing circuitry 118 may process a plurality of measurements signals and generate a 3D point cloud based on the plurality of measurement signals. In some implementations, in which the plurality of light beams is used, the system controller 106 may be configured to generate the control signal CTRL used for triggering the light transmitter 108 to generate the plurality of light beams. Using the control signal CTRL, the system controller 106 can control the transmission times of the plurality of light beams of the light transmitter 108 to achieve a desired illumination pattern within the field-of-view. The desired illumination pattern is produced by a combination of the 2D scanning pattern produced by the scanner 102 and the transmission times triggered by the system controller 106.

Accordingly, the 2D scanning system 100A may include a detector that includes at least one sensor (e.g., sensor 110) and at least one signal processor (e.g., the processing circuitry 118 or other additional processors and/or processing components) implemented, for example, in the system controller 106. The sensor 110 may generate electrical signals based on reflected light beams corresponding to the light beams transmitted by the light transmitter 108. The sensor 110 may transmit the electrical signals to processing circuitry 118. The processing circuitry 118 may be configured to process the electrical signals to generate distance measurements based on the machine instructions for generating the 3D point cloud.

In some implementations, the scanner 102 may be a galvanometer scanner. The galvanometer scanner may include a shaft for each scanning axis, a first galvanometer-based scanning motor that drives a rotation of a first shaft associated with the first scanning axis 112, a second galvanometer-based scanning motor that drives a rotation of a second shaft associated with the second scanning axis 114, an optical mirror mounted to both the first shaft and the second shaft, and a detector that provides positional feedback (e.g., an actual angle measurement for each scanning axis or a vector measurement) to the system controller 106. The driver system 104 may include a first servo driver for driving the first galvanometer-based scanning motor, and a second servo driver for driving the second galvanometer-based scanning motor. Each servo driver may generate a driving signal (e.g., a drive current) based on a command position (e.g., an angle setpoint) that is provided to the servo driver by a control loop. Each servo driver may supply the driving signal to a respective galvanometer-based scanning motor. The system controller 106 may monitor a difference representing an error between the command position (e.g., the angle setpoint) and an actual position (e.g., the actual angle measurement) to adjust the command position based on the difference.

The driver system 104 may receive, from the system controller 106, an angle vector setpoint corresponding to a two-dimensional scanning coordinate, drive the scanner 102 about the first scanning axis 112 with the first driving signal based on the angle vector setpoint, and drive the scanner 102 about the second scanning axis 114 with the second driving signal based on the angle vector setpoint. The angle vector setpoint may include a first angle setpoint for the first scanning axis 112 and a second angle setpoint for the second scanning axis 114.

The system controller 106 may be configured with a dynamic model of the scanner 102. The system controller 106 may generate a first estimated angle measurement signal based on the angle vector setpoint and the dynamic model. The first estimated angle measurement signal may a first angular trajectory of the scanner 102 about the first scanning axis 112. Additionally, the system controller 106 may generate a second estimated angle measurement signal based on the angle vector setpoint and the dynamic model. The second estimated angle measurement signal may follow a second angular trajectory of the scanner 102 about the second scanning axis 114. Since the first estimated angle measurement signal and the second estimated angle measurement signal are generated based on the dynamic model, the first estimated angle measurement signal and the second estimated angle measurement signal may be free of or substantially free of angle measurement noise. In other words, the system controller 106 may remove angle measurement noise based on the dynamic model to generate the first estimated angle measurement signal and the second estimated angle measurement signal.

In some implementations, the system controller 106 may generate estimated angle vector measurement signal based on the angle vector setpoint, an angle measurement vector signal, and the dynamic model. The estimated angle vector measurement signal may represent a combination of the first estimated angle measurement signal and the second estimated angle measurement signal.

In some implementations, the driver system 104 may include a first angle position detector configured to generate a first angle measurement signal based on detecting a first angular position of the scanner 102 about the first scanning axis 112, and a second angle position detector configured to generate a second angle measurement signal based on detecting a second angular position of the scanner 102 about the second scanning axis 114. The angle measurement vector signal may represent a combination of the first angle measurement signal and the second angle measurement signal. The driver system 104 may provide the first angle measurement signal and the second angle measurement signal to the system controller 106 as positional feedback.

The system controller 106 may also receive distance measurements from the sensor 110. The system controller 106 may associate a distance measurement with a first estimated angle value corresponding to the first estimated angle measurement signal, associate the distance measurement with a second estimated angle value corresponding to the second estimated angle measurement signal, and generate a point in a 3D point cloud based on the distance measurement, the first estimated angle value, and the second estimated angle value. Since the first estimated angle measurement signal and the second estimated angle measurement signal are free of or substantially free of angle measurement noise, a 3D-coordinate of the point within the 3D point cloud may be more accurate than would otherwise be possible if the angle measurement noise were still present.

As indicated above, FIG. 1 is provided as an example. Other examples may differ from what is described with regard to FIG. 1. In practice, the 2D scanning system 100A may include additional components, fewer components, different components, or differently arranged components than those shown in FIG. 1 without deviating from the disclosure provided above. In addition, in some implementations, the 2D scanning system 100A may include one or more additional mirrors to scan the field-of-view.

FIG. 1B is a schematic block diagram of a 2D scanning system 100B according to one or more implementations. In particular, the 2D scanning system 100B includes two scanners, a first scanner 102x and a second scanner 102y, that are optically coupled in series to steer or otherwise deflect light beams according to a 2D scanning pattern. The first scanner 102x and the second scanner 102y are similar to the scanner 102 described in FIG. 1A, with the exception that the first scanner 102x and the second scanner 102y are configured to rotate about a single scanning axis instead of two scanning axes. The first scanner 102x is configured to rotate about the first scanning axis 112 to steer light in the x-direction, and the second scanner 102y is configured to rotate about the second scanning axis 114 to steer light in the y-direction. Similar to the scanner 102 described in FIG. 1A, the first scanner 102x and the second scanner 102y may be galvanometer scanners configured to be driven by a respective galvanometer-based scanning motor.

Because each of the first scanner 102x and the second scanner 102y is configured to rotate about a single scanning axis, each of the first scanner 102x and the second scanner 102y is responsible for scanning light in one dimension. As a result, the first scanner 102x and the second scanner 102y may be referred to as one-dimensional (1D) scanner. In the example shown in FIG. 1B, the first scanner 102x and the second scanner 102y are used together to steer light beams in two dimensions. The first scanner 102x and the second scanner 102y are arranged sequentially along a transmission path of the light beams such that one of the scanners (e.g., the first scanner 102x) first receives a light beam and steers the light beam in a first dimension, and the second one of the scanners (e.g., the second scanner 102y) receives the light beam from the first scanner 102x and steers the light beam in a second dimension. As a result, the first scanner 102x and the second scanner 102y operate together to steer the light beam generated by the light transmitter 108 in two dimensions. In this way, the first scanner 102x and the second scanner 102y can direct the light beam at a desired 2D coordinate (e.g., an x-y coordinate) in the field-of-view. Multiple light beams can be steered by the first scanner 102x and the second scanner 102y at different 2D coordinates of a 2D scanning pattern.

The driver system 104, the system controller 106, and the light transmitter 108 are configured to operate as similarly described above in reference to FIG. 1A. The driver 116 may be electrically coupled to the first scanner 102x to drive the first scanner 102x about the first scanning axis 112, and the driver system 104 may detect a position (e.g., an angular position) of the first scanner 102x about the first scanning axis 112 to provide first position information to the system controller 106. Similarly, the driver 116 may be electrically coupled to the second scanner 102y to drive the second scanner 102y about the second scanning axis 114, and the driver system 104 may detect a position (e.g., an angular position) of the second scanner 102y about the second scanning axis 114 to send a position of the second scanner 102y about the second scanning axis 114 to provide second position information to the system controller 106.

In some implementations, the first scanner 102x may be a first galvanometer scanner configured to rotate about the first scanning axis 112 based on a first driving signal, and the second scanner 102y may be a second galvanometer scanner configured to rotate about the second scanning axis 114 based on a second driving signal.

A shaft may be provided for each scanning axis. The driver system 104 may include a first galvanometer-based scanning motor that drives a rotation of a first shaft associated with the first scanning axis 112, a second galvanometer-based scanning motor that drives a rotation of a second shaft associated with the second scanning axis 114, and detectors that provide positional feedback (e.g., an actual angle measurement for each scanning axis) to the system controller 106. The driver system 104 may include a first servo driver for driving the first galvanometer-based scanning motor, and a second servo driver for driving the second galvanometer-based scanning motor. Each servo driver may generate a driving signal (e.g., a drive current) based on a command position (e.g., an angle setpoint) that is provided to the servo driver by a control loop. Each servo driver may supply the driving signal to a respective galvanometer-based scanning motor. The system controller 106 may monitor a difference representing an error between the command position (e.g., the angle setpoint) and an actual position (e.g., the actual angle measurement) to adjust the command position based on the difference.

The driver system 104 may receive, from the system controller 106, a first angle setpoint for the first galvanometer scanner and a second angle setpoint for the second galvanometer scanner, drive the first galvanometer scanner with the first driving signal based on the first angle setpoint, and drive the second galvanometer scanner with the second driving signal based on the second angle setpoint.

The system controller 106 may be configured with a dynamic model of the two-dimensional scanner. The dynamic model of the two-dimensional scanner may include a first dynamic model of the first scanner 102x, and a second dynamic model of the second scanner 102y, or may be a combined dynamic model for both the first scanner 102x and the second scanner 102y. The system controller 106 may generate a first estimated angle measurement signal based on the first angle setpoint and the dynamic model (e.g., the first dynamic model or the combined dynamic model). The first estimated angle measurement signal may follow a first angular trajectory of the first scanner 102x about the first scanning axis 112. Additionally, the system controller 106 may generate a second estimated angle measurement signal based on the second angle setpoint and the dynamic model (e.g., the second dynamic model or the combined dynamic model). The second estimated angle measurement signal may follow a second angular trajectory of the second scanner 102y about the second scanning axis 114. Since the first estimated angle measurement signal and the second estimated angle measurement signal are generated based on the dynamic model of the two-dimensional scanner, the first estimated angle measurement signal and the second estimated angle measurement signal may be free of or substantially free of angle measurement noise. In other words, the system controller 106 may remove angle measurement noise based on the dynamic model to generate the first estimated angle measurement signal and the second estimated angle measurement signal.

In some implementations, the driver system 104 may include a first angle position detector configured to generate a first angle measurement signal based on detecting a first angular position of the first scanner 102x about the first scanning axis 112, and a second angle position detector configured to generate a second angle measurement signal based on detecting a second angular position of the second scanner 102y about the second scanning axis 114. The driver system 104 may provide the first angle measurement signal and the second angle measurement signal to the system controller 106 as positional feedback.

The system controller 106 may also receive distance measurements from the sensor 110. The system controller 106 may associate the distance measurement with a first estimated angle value corresponding to the first estimated angle measurement signal, associate the distance measurement with a second estimated angle value corresponding to the second estimated angle measurement signal, and generate a point in a three-dimensional point cloud based on the distance measurement, the first estimated angle value, and the second estimated angle value. Since the first estimated angle measurement signal and the second estimated angle measurement signal are free of or substantially free of angle measurement noise, a 3D-coordinate of the point within the 3D point cloud may be more accurate than would otherwise be possible if the angle measurement noise were still present.

As indicated above, FIG. 1B is provided as an example. Other examples may differ from what is described with regard to FIG. 1B. In practice, the 2D scanning system 100B may include additional components, fewer components, different components, or differently arranged components than those shown in FIG. 1B without deviating from the disclosure provided above. In addition, in some implementations, the 2D scanning system 100B may include one or more additional 1D MEMS mirrors or one or more additional light transmitters used to scan one or more additional field-of-views. Additionally, two or more components shown in FIG. 1B may be implemented within a single component, or a single component shown in FIG. 1B may be implemented as multiple, distributed components. Additionally, or alternatively, a set of components (e.g., one or more components) of the 2D scanning system 100B may perform one or more functions described as being performed by another set of components of the 2D scanning system 100B.

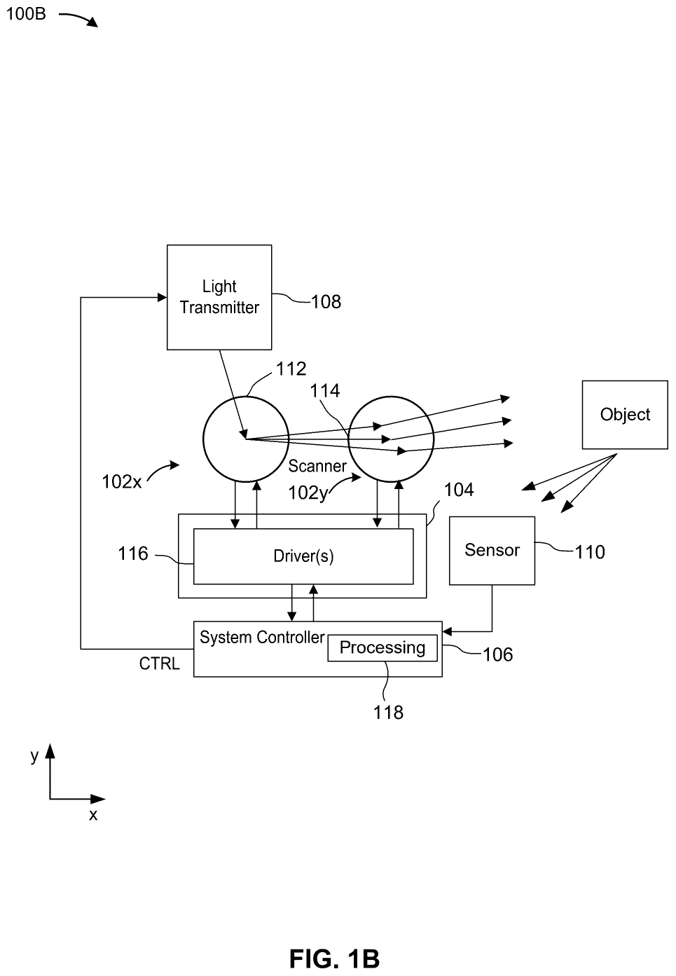

FIG. 2 shows a control loop 200 of a beam scanning system according to one or more implementations. The control loop 200 may be implemented for the scanner 102 described in connection with FIG. 1A, the first scanner 102x described in connection with FIG. 1B, or the second scanner 102y described in connection with FIG. 1B. The control loop 200 may be duplicated for each scanning axis. In other words, separate control loops 200 may be provided for the first scanning axis 112 and the second scanning axis 114.

The control loop 200 includes the driver 116 that generates a driving signal (e.g., a drive current), and a scanner 102x,y corresponding to one of the scanners described in connection with FIGS. 1A and 1B. The scanner 102x,y is driven about a scanning axis based on the driving signal. An angle position detector may be integrated with the scanner 102x,y and may be configured to detect an angular position (e.g., a rotation angle θ) of the scanner 102x,y about the scanning axis, and generate an actual angle measurement signal based on the angular position. The actual angle measurement signal provided by the angle position detector may represent an actual mirror angle θ of the scanner 102x,y.

A summer 202 may provide an angle measurement signal θmeas based on the actual angle measurement signal and angle measurement noise. In other words, the summer 202 may represent angle measurement noise being added to the actual angle measurement signal, which may corrupt the angle measurement signal (e.g., the actual mirror angle θ) to produce the angle measurement signal θmeas. Thus, the angle measurement signal θmeas may be a noisy measurement signal. For example, the summer 202 may represent any signal line, component, and/or combination of signal lines or components that introduce noise onto the actual angle measurement signal.

An error detector 204 may receive an angle setpoint θsp for the scanner 102x,y. The angle setpoint θsp may be a control value corresponding to a target angular position of the scanner 102x,y. The angle setpoint θsp may be provided in setpoint control signal that corresponds to a target angular trajectory of the scanner 102x,y. Additionally, the error detector 204 may receive the angle measurement signal θmeas, which may be corrupted by noise. The error detector 204 may generate an error signal that represents a difference between the angle setpoint θsp and the angle measurement signal θmeas. The driver 116 may adjust the driving signal in order to drive the error signal to zero. Thus, noise included in the angle measurement signal θmeas may cause the driver 116 to generate an incorrect driving signal.

Alternatively, the error detector 204 may be provided with an estimated angle measurement signal instead of the angle measurement signal θmeas provided by the summer 202. The estimated angle measurement signal fest may be generated based on a dynamic model of the scanner 102x,y. As a result, the estimated angle measurement signal θest may be free of or substantially free of angle measurement noise, which may lead to more accurate control of the angular position of the scanner 102x,y. For example, the driver 116 may generate the driving signal based on a difference between the estimated angle measurement signal θest and the setpoint control signal. Thus, the driver 116 may compensate the driving signal based on a difference between the estimated angle measurement signal and the setpoint control signal. In other words, the driver may generate the driving signal based on the difference between the estimated angle measurement signal and the angle setpoint θsp (or angle vector setpoint θvsp) provided by the setpoint control signal.

In some implementations, the angle setpoint θsp may be an angle vector setpoint, the estimated angle measurement signal θest may be an estimated angle vector measurement signal that is based on the angle vector setpoint, and the angle measurement signal θmeas may be an angle measurement vector signal. The angle vector setpoint, the angle measurement vector signal, and/or the estimated angle vector measurement signal may be used to drive both scanning axes 112 and 114. For example, angle vectors may be used in the 2D scanning system 100A described in connection with FIG. 1A. The first scanning axis 112 and the second scanning axis 114 of the scanner 102 (e.g., the 2D scanning mirror) may be cross-coupled by one or more cross-coupling effects or interactions. Thus, motion about the first scanning axis 112 may affect motion about the second scanning axis 114, and vice versa. Thus, the angle vector setpoint, the angle measurement vector signal, and/or the estimated angle vector measurement signal may take into account the one or more cross-coupling effects or interactions between the scanning axes 112 and 114.

As indicated above, FIG. 2 is provided as an example. Other examples may differ from what is described with regard to FIG. 2.

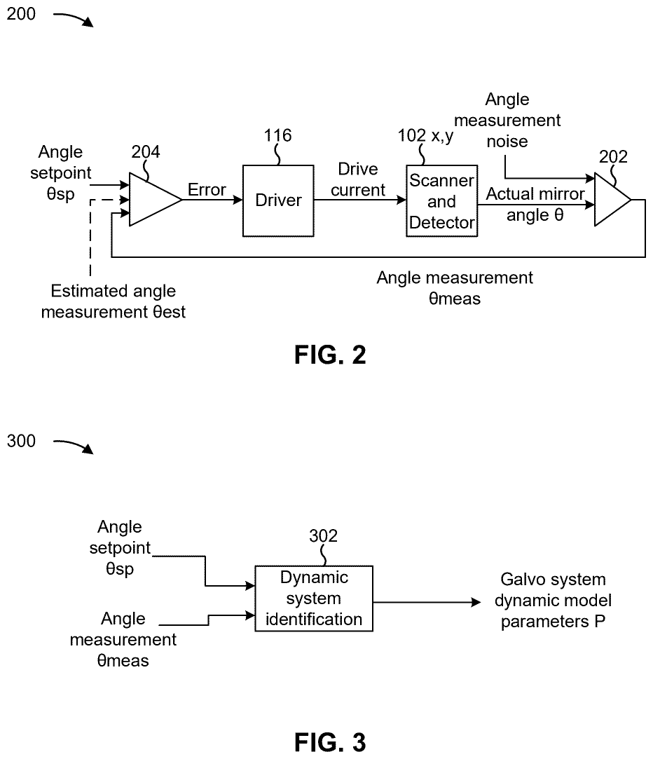

FIG. 3 shows a modeling system 300 according to one or more implementations. The modeling system 300 may include a dynamic system identification processor 302 configured to generate a dynamic model of a two-dimensional scanner based on a plurality of input data. For example, the dynamic system identification processor 302 may receive a setpoint control signal and an angle measurement signal θmeas. The setpoint control signal may provide angle setpoints θsp corresponding to a target angular trajectory. The angle measurement signal θmeas may be provided by the summer 202 derived in connection with FIG. 2. For each angle setpoints θsp, the dynamic system identification processor 302 may provide dynamic model parameter values that corresponds to a response or a behavior of the two-dimensional scanner. Thus, the dynamic system identification processor 302 may generate the dynamic model that models the behavior of the two-dimensional scanner for the entire target angular trajectory of the two-dimensional scanner. Since the angle measurement signal θmeas, which may be a noisy measurement signal, is used as an input, the dynamic model may take into account any noise that be present during dynamic system modeling, which may naturally occur during operation of the two-dimensional scanner.

The dynamic system identification processor 302 may execute a modeling algorithm, such as subspace identification, arx modeling, or back-box/grey-box model parametric optimization for performing the dynamic system modeling. In addition, model-fitting may include using normal scan measurement data as an input, or may use setpoints with specially tailored spectral content, for example, with filtered broadband noise, to improve a richness of the data used for the dynamic system modeling. The behavior of the two-dimensional scanner should not change significantly over time. Thus, the dynamic system modeling may be performed at periodic intervals or upon system startup. The modeling system 300 may be incorporated into the system controller 106 and may be performed by the processing circuitry 118.

As indicated above, FIG. 3 is provided as an example. Other examples may differ from what is described with regard to FIG. 3.

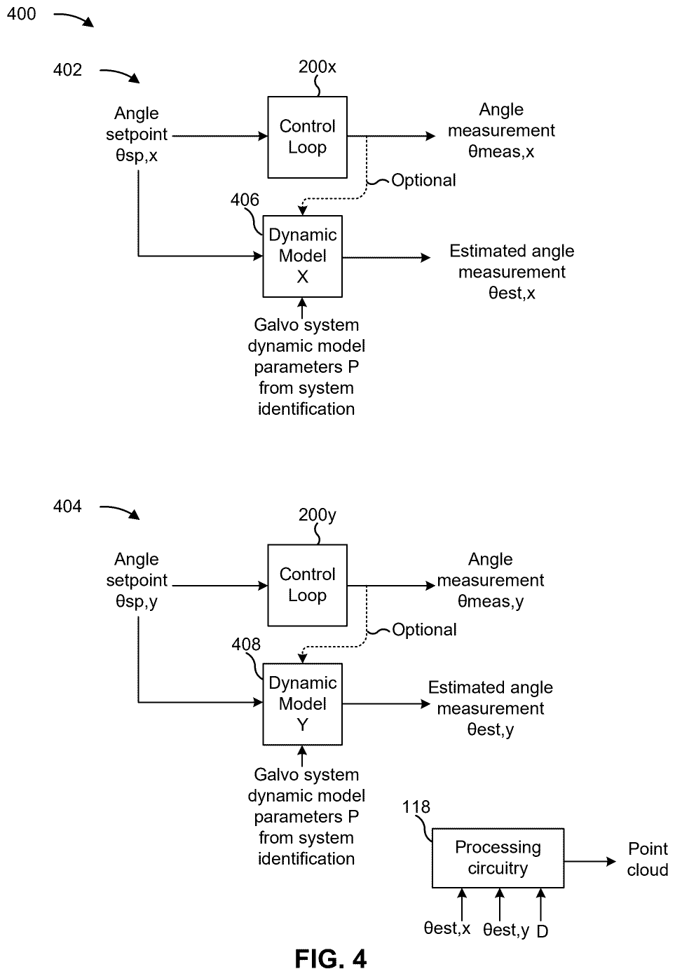

FIG. 4 shows a system 400 according to one or more implementations. The system 400 may include a first processing system 402 corresponding to the first scanning axis 112, and a second processing system 404 corresponding to the second scanning axis 114. Thus, the first processing system 402 and the second processing system 404 may be used in the 2D scanning system 100A described in conjunction with FIG. 1A or the 2D scanning system 100B described in conjunction with FIG. 1B.

The first processing system 402 may include a control loop 200x that is similar to the control loop 200 described in connection with FIG. 2. The control loop 200x may be configured for driving a galvanometer scanner about the first scanning axis 112 and obtaining a first estimated angle measurement signal θest,x that may be provided to a processing component of the processing circuitry 118 for generating point cloud data. The galvanometer scanner may be the scanner 102 or the first scanner 102x. In the following examples, it will be assumed that the galvanometer scanner controlled by the control loop 200x corresponds to the first scanner 102x.

A driver system (e.g., driver system 104) of the control loop 200x may receive a first angle setpoint θsp,x for the first scanner 102x, and drive the first scanner 102x with a first driving signal based on the first angle setpoint θsp,x. A first angle position detector of the control loop 200x may generate a first angle measurement signal θmeas,x based on detecting a first angular position of the first scanner 102x about the first scanning axis 112. The first angle measurement signal θmeas,x may be a noisy measurement signal.

A processor 406, implemented in the system controller 106, may be configured with a dynamic model X that models the behavior of the first scanner 102x about the first scanning axis 112. The processor 406 may generate the first estimated angle measurement signal θest,x based on the first angle setpoint θsp,x and the dynamic model X. The first estimated angle measurement signal θest,x may follow a first angular trajectory of the first scanner 102x about the first scanning axis 112.

In some implementations, the processor 406 may generate the first estimated angle measurement signal θest,x based the first angle measurement signal θmeas,x, in addition to the first angle setpoint θsp,x and the dynamic model X. Using both the first angle setpoint θsp,x and the first angle measurement signal θmeas,x as inputs to the dynamic model X may constitute a type of state observer or Kalman filtering algorithm, where the first estimated angle measurement signal θest,x is an optimal measurement of the state of the first scanner 102x about the first scanning axis 112.

Thus, the system controller 106 may apply the first angle setpoint θsp,x as a first input to the dynamic model X to obtain a first estimated angle value as a first output from the dynamic model X. The processor 406 may remove angle measurement noise based on the dynamic model X to generate the first estimated angle measurement signal θest,x. Thus, the processor 406 may generate the first estimated angle measurement signal θest,x to be substantially free of angle measurement noise based on the dynamic model X.

In some implementations, the processor 406 may remove a first angle measurement noise component from the first angle measurement signal θmeas,x to generate the first estimated angle measurement signal θest,x based on applying the first angle setpoint θsp,x and the first angle measurement signal θmeas,x as first inputs to the dynamic model X. For example, the processor 406 may, based on receiving the first angle setpoint θsp,x as a first input to the dynamic model X, attenuate a first angle measurement noise from the first angle measurement signal θmeas,x to generate the first estimated angle measurement signal θest,x. In some implementations, the processor 406 may include a noise attenuating filter programmed by the dynamic model X, and the noise attenuating filter may output the first estimated angle measurement signal θest,x based on the first angle setpoint θsp,x.

The second processing system 404 may include a control loop 200y that is similar to the control loop 200 described in connection with FIG. 2. The control loop 200y may be configured for driving a galvanometer scanner about the second scanning axis 114 and obtaining a second estimated angle measurement signal θest,y that may be provided to a processing component of the processing circuitry 118 for generating point cloud data. The galvanometer scanner may be the scanner 102 or the second scanner 102y. In the following examples, it will be assumed that the galvanometer scanner controlled by the control loop 200y corresponds to the second scanner 102y.

A driver system (e.g., driver system 104) of the control loop 200y may receive a second angle setpoint θsp,y for the second scanner 102y, and drive the second scanner 102y with a second driving signal based on the second angle setpoint θsp,y. A second angle position detector of the control loop 200y may generate a second angle measurement signal θmeas,y based on detecting a second angular position of the second scanner 102y about the second scanning axis 114. The second angle measurement signal θmeas,y may be a noisy measurement signal.

A processor 408, implemented in the system controller 106, may be configured with a dynamic model Y that models the behavior of the second scanner 102y about the second scanning axis 114. The processor 406 and the processor 408 may be a same processor or may be separate processors. Likewise the dynamic model X and the dynamic model Y may be part of a larger system model or may be separate system models that represent a dynamic model of the two-dimensional scanner.

The processor 408 may generate the second estimated angle measurement signal θest,y based on the second angle setpoint θsp,y and the dynamic model Y. The second estimated angle measurement signal θest,y may follow a second angular trajectory of the second scanner 102y about the second scanning axis 114.

In some implementations, the processor 408 may generate the second estimated angle measurement signal θest,y based the second angle measurement signal θmeas,y, in addition to the second angle setpoint θsp,y and the dynamic model Y. Using both the second angle setpoint θsp,y and the second angle measurement signal θmeas,y as inputs to the dynamic model Y may constitute a type of state observer or Kalman filtering algorithm, where the second estimated angle measurement signal θest,y is an optimal measurement of the state of the second scanner 102y about the second scanning axis 114.

Thus, the system controller 106 may apply the second angle setpoint θsp,y as a second input to the dynamic model Y to obtain a second estimated angle value as a second output from the dynamic model Y. The processor 408 may remove angle measurement noise based on the dynamic model Y to generate the second estimated angle measurement signal θest,y. Thus, the processor 408 may generate the second estimated angle measurement signal θest,y to be substantially free of angle measurement noise based on the dynamic model Y.

In some implementations, the processor 408 may remove a second angle measurement noise component from the second angle measurement signal θmeas,y to generate the second estimated angle measurement signal θest,y based on applying the second angle setpoint θsp,y and the second angle measurement signal θmeas,y as second inputs to the dynamic model Y. For example, the processor 408 may, based on receiving the second angle setpoint θsp,y as a second input to the dynamic model Y, attenuate a second angle measurement noise from the second angle measurement signal θmeas,y to generate the second estimated angle measurement signal θest,y. In some implementations, the processor 408 may include a noise attenuating filter programmed by the dynamic model Y, and the noise attenuating filter may output the second estimated angle measurement signal θest,y based on the second angle setpoint θsp,y.

The processing circuitry 118 may receive the first estimated angle measurement signal θest,x, the second estimated angle measurement signal θest,y, and a distance measurement signal D. The distance measurement signal D may be provided by the sensor 110 and may include distance measurements obtained from one or more reflected light beams.

The processing circuitry 118 may associate a distance measurement with a first estimated angle value corresponding to the first estimated angle measurement signal θest,x, associate the distance measurement with a second estimated angle value corresponding to the second estimated angle measurement signal θest,y, and generate a point in a 3D point cloud based on the distance measurement, the first estimated angle value, and the second estimated angle value.

As indicated above, FIG. 4 is provided as an example. Other examples may differ from what is described with regard to FIG. 4. In practice, the system 400 may include additional components, fewer components, different components, or differently arranged components than those shown in FIG. 4 without deviating from the disclosure provided above. Additionally, two or more components shown in FIG. 4 may be implemented within a single component, or a single component shown in FIG. 4 may be implemented as multiple, distributed components. Additionally, or alternatively, a set of components (e.g., one or more components) of the system 400 may perform one or more functions described as being performed by another set of components of the system 400.

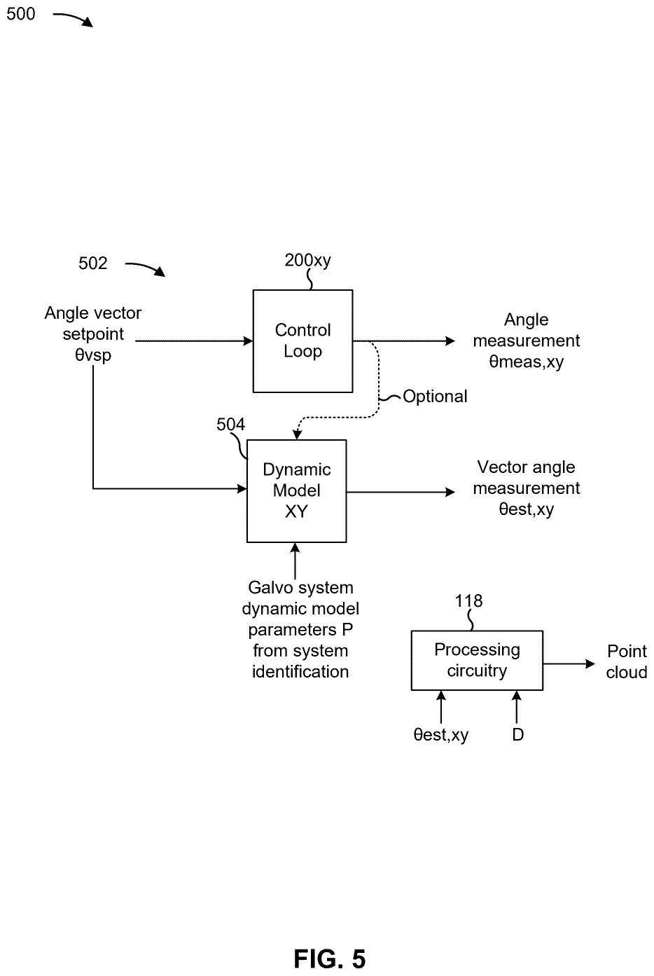

FIG. 5 shows a system 500 according to one or more implementations. The system 500 may include a processing system 502 corresponding to the first scanning axis 112 and the second scanning axis 114. Thus, the processing system 502 may be used in the 2D scanning system 100B described in conjunction with FIG. 1B.

The processing system 502 may include a control loop 200xy that is similar to the control loop 200 described in connection with FIG. 2, but may operate based on angle vectors. The control loop 200xy may be configured for driving a galvanometer scanner about the first scanning axis 112 and about the second scanning axis 114, and obtaining an estimated angle vector measurement signal θest,xy that may be provided to a processing component of the processing circuitry 118 for generating point cloud data. The galvanometer scanner may be the scanner 102.

A driver system (e.g., driver system 104) of the control loop 200xy may receive an angle vector setpoint θvsp corresponding to a two-dimensional scanning coordinate, drive the scanner 102 about the first scanning axis 112 with the first driving signal based on the angle vector setpoint θvsp, and drive the scanner 102 about the second scanning axis 114 with the second driving signal based on the angle vector setpoint θvsp. A first angle position detector of the control loop 200xy may generate a first angle measurement signal θmeas,x based on detecting a first angular position of the first scanner 102 about the first scanning axis 112. A second angle position detector of the control loop 200xy may generate a second angle measurement signal θmeas,y based on detecting a second angular position of the scanner 102y about the second scanning axis 114. The first angle measurement signal θmeas,x and the second angle measurement signal θmeas,y may be noisy measurement signals. The control loop 200xy may combine the first angle measurement signal θmeas,x and the second angle measurement signal θmeas,y to generate an angle measurement vector signal θmeas,xy, which may also be a noisy signal.

A processor 504, implemented in the system controller 106, may be configured with a dynamic model XY that models the behavior of the scanner 102 about the first scanning axis 112 and the second scanning axis 114, and may model cross-coupling effects of the first scanning axis 112 and the second scanning axis 114. The processor 504 may generate a first estimated angle measurement signal θest,x based on the angle vector setpoint θvsp and the dynamic model XY. The first estimated angle measurement signal θest,x may follow a first angular trajectory of the scanner 102 about the first scanning axis 112. Additionally, the processor 504 may generate a second estimated angle measurement signal θest,y based on the angle vector setpoint θvsp and the dynamic model XY. The second estimated angle measurement signal θest,y may follow a second angular trajectory of the scanner 102 about the second scanning axis 114.

In some implementations, the processor 504 may generate the first estimated angle measurement signal θest,x based on the angle vector setpoint θvsp, the first angle measurement signal θmeas,x, and the dynamic model XY. Additionally, the processor 504 may generate the second estimated angle measurement signal θest,y based on the angle vector setpoint θvsp, the second angle measurement signal θmeas,y, and the dynamic mode XY.

In some implementations, the processor 504 may combine the first estimated angle measurement signal θest,x and the second estimated angle measurement signal θest,y to generate the estimated angle vector measurement signal θest,xy.

In some implementations, the processor 504 may generate the estimated angle vector measurement signal θest,xy based on the angle vector setpoint θvsp, the angle measurement vector signal θmeas,xy, and the dynamic model XY.

The system controller 106 may to apply the angle vector setpoint θvsp as an input to the dynamic model XY to obtain a first estimated angle value as a first output from the dynamic model XY and to obtain a second estimated angle value as a second output from the dynamic model XY. The processor 504 may remove angle measurement noise based on the dynamic model XY to generate the first estimated angle measurement signal θest,x and the second estimated angle measurement signal θest,y. The processor 504 may generate the first estimated angle measurement signal θest,x and the second estimated angle measurement signal θest,y substantially free of angle measurement noise based on the dynamic model XY. For example, the processor 504 may remove a first angle measurement noise component from the first angle measurement signal θmeas,x to generate the first estimated angle measurement signal θest,x based on applying the angle vector setpoint θvsp and the first angle measurement signal θmeas,x as first inputs to the dynamic model XY. Additionally, the processor 504 may remove a second angle measurement noise component from the second angle measurement signal θmeas,y to generate the second estimated angle measurement signal θest,y based on applying the angle vector setpoint θvsp and the second angle measurement signal θmeas,y as second inputs to the dynamic model XY. Alternatively, the processor 504 may remove measurement noise from the measurement vector signal θmeas,xy based on the angle vector setpoint θvsp in order to generate the estimated angle vector measurement signal θest,xy.

In some implementations, the processor 504 may, based on receiving the angle vector setpoint θvsp as an input to the dynamic model XY, attenuate a first angle measurement noise from the first angle measurement signal θmeas,x to generate the first estimated angle measurement signal θest,x, and attenuate a second angle measurement noise from the second angle measurement signal θmeas,y to generate the second estimated angle measurement signal θest,x. For example, the processor 504 may include a noise attenuating filter programmed by the dynamic model XY, and the noise attenuating filter may output the first estimated angle measurement signal θest,x and the second estimated angle measurement signal θest,y based on the angle vector setpoint θvsp.

In some implementations, the processor 504 may, based on receiving the angle vector setpoint θvsp as an input to the dynamic model XY, attenuate angle measurement noise from the measurement vector signal θmeas,xy to generate the estimated angle vector measurement signal θest,xy. For example, the processor 504 may include a noise attenuating filter programmed by the dynamic model XY based on the angle vector setpoint θvsp.

The processing circuitry 118 may receive the first estimated angle measurement signal θest,x, the second estimated angle measurement signal θest,y, and a distance measurement signal D. The distance measurement signal D may be provided by the sensor 110 and may include distance measurements obtained from one or more reflected light beams.

The processing circuitry 118 may associate a distance measurement with a first estimated angle value corresponding to the first estimated angle measurement signal θest,x, associate the distance measurement with a second estimated angle value corresponding to the second estimated angle measurement signal θest,y, and generate a point in a 3D point cloud based on the distance measurement, the first estimated angle value, and the second estimated angle value.

Alternatively, the processing circuitry 118 may receive the estimated angle vector measurement signal θest,xy, associate a distance measurement with a first estimated angle value corresponding to the estimated angle vector measurement signal θest,xy, associate the distance measurement with a second estimated angle value corresponding to the estimated angle vector measurement signal θest,xy, and generate a point in a 3D point cloud based on the distance measurement, the first estimated angle value, and the second estimated angle value.

As indicated above, FIG. 5 is provided as an example. Other examples may differ from what is described with regard to FIG. 5. In practice, the system 500 may include additional components, fewer components, different components, or differently arranged components than those shown in FIG. 5 without deviating from the disclosure provided above. Additionally, two or more components shown in FIG. 5 may be implemented within a single component, or a single component shown in FIG. 5 may be implemented as multiple, distributed components. Additionally, or alternatively, a set of components (e.g., one or more components) of the system 500 may perform one or more functions described as being performed by another set of components of the system 500.

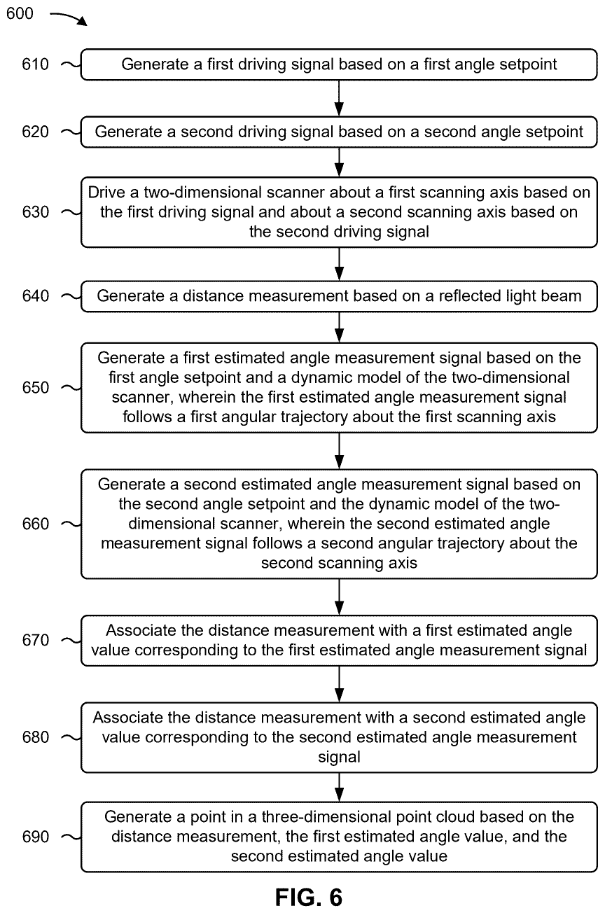

FIG. 6 is a flowchart of an example process 600 associated with a beam scanning method. The beam scanning method may include a method for attenuating effects of galvanometer angle measurement noise in a scanner point cloud. In some implementations, one or more process blocks of FIG. 6 are performed by a beam scanning system (e.g., system 400 or system 500). For example, one or more process blocks of FIG. 6 may be performed by one or more components of system 400 or system 500, which may include modeling system 300.

The example process 600 may include generating a first driving signal based on a first angle setpoint (block 610); generating a second driving signal based on a second angle setpoint (block 620); driving a two-dimensional scanner about a first scanning axis based on the first driving signal and about a second scanning axis based on the second driving signal (block 630); generating a distance measurement based on a reflected light beam (block 640); generating a first estimated angle measurement signal based on the first angle setpoint and a dynamic model of the two-dimensional scanner, wherein the first estimated angle measurement signal follows a first angular trajectory about the first scanning axis (block 650); generating a second estimated angle measurement signal based on the second angle setpoint and the dynamic model of the two-dimensional scanner, wherein the second estimated angle measurement signal follows a second angular trajectory about the second scanning axis (block 660); associating the distance measurement with a first estimated angle value corresponding to the first estimated angle measurement signal (block 670); associating the distance measurement with a second estimated angle value corresponding to the second estimated angle measurement signal (block 680); and generating a point in a three-dimensional point cloud based on the distance measurement, the first estimated angle value, and the second estimated angle value (block 690).

Process 600 may include additional implementations, such as any single implementation or any combination of implementations described below and/or in connection with one or more other processes described elsewhere herein.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The following provides an overview of some Aspects of the present disclosure:

Aspect 1: A beam scanning system, comprising: a two-dimensional scanner comprising a first galvanometer scanner configured to rotate about a first scanning axis based on a first driving signal, and a second galvanometer scanner configured to rotate about a second scanning axis based on a second driving signal; a time-of-flight sensor configured to receive a reflected light beam and generate a distance measurement based on the reflected light beam; a driver system configured to receive a first angle setpoint for the first galvanometer scanner and a second angle setpoint for the second galvanometer scanner, drive the first galvanometer scanner with the first driving signal based on the first angle setpoint, and drive the second galvanometer scanner with the second driving signal based on the second angle setpoint; and a system controller configured with a dynamic model of the two-dimensional scanner, wherein the system controller is configured to generate a first estimated angle measurement signal based on the first angle setpoint and the dynamic model, wherein the first estimated angle measurement signal follows a first angular trajectory of the first galvanometer scanner about the first scanning axis, wherein the system controller is configured to generate a second estimated angle measurement signal based on the second angle setpoint and the dynamic model, wherein the second estimated angle measurement signal follows a second angular trajectory of the second galvanometer scanner about the second scanning axis, and wherein the system controller is configured to associate the distance measurement with a first estimated angle value corresponding to the first estimated angle measurement signal, associate the distance measurement with a second estimated angle value corresponding to the second estimated angle measurement signal, and generate a point in a three-dimensional point cloud based on the distance measurement, the first estimated angle value, and the second estimated angle value.

Aspect 2: The beam scanning system of Aspect 1, wherein the system controller is configured to apply the first angle setpoint as a first input to the dynamic model to obtain the first estimated angle value as a first output from the dynamic model, and wherein the system controller is configured to apply the second angle setpoint as a second input to the dynamic model to obtain the second estimated angle value as a second output from the dynamic model.

Aspect 3: The beam scanning system of any of Aspects 1-2, wherein the system controller is configured to remove angle measurement noise based on the dynamic model to generate the first estimated angle measurement signal and the second estimated angle measurement signal.

Aspect 4: The beam scanning system of any of Aspects 1-3, wherein the system controller is configured to generate the first estimated angle measurement signal and the second estimated angle measurement signal substantially free of angle measurement noise based on the dynamic model.

Aspect 5: The beam scanning system of any of Aspects 1-4, further comprising: a first angle position detector configured to generate a first angle measurement signal based on detecting a first angular position of the first galvanometer scanner about the first scanning axis; and a second angle position detector configured to generate a second angle measurement signal based on detecting a second angular position of the second galvanometer scanner about the second scanning axis, wherein the system controller is configured to generate the first estimated angle measurement signal based on the first angle setpoint, the first angle measurement signal, and the dynamic model, and wherein the system controller is configured to generate the second estimated angle measurement signal based on the second angle setpoint, the second angle measurement signal, and the dynamic model.

Aspect 6: The beam scanning system of Aspect 5, wherein the system controller is configured to remove a first angle measurement noise component from the first angle measurement signal to generate the first estimated angle measurement signal based on applying the first angle setpoint and the first angle measurement signal as first inputs to the dynamic model, and wherein the system controller is configured to remove a second angle measurement noise component from the second angle measurement signal to generate the second estimated angle measurement signal based on applying the second angle setpoint and the second angle measurement signal as second inputs to the dynamic model.

Aspect 7: The beam scanning system of Aspect 5, wherein the system controller is configured to, based on receiving the first angle setpoint as a first input to the dynamic model, attenuate a first angle measurement noise from the first angle measurement signal to generate the first estimated angle measurement signal, and wherein the system controller is configured to, based on receiving the second angle setpoint as a second input to the dynamic model, attenuate a second angle measurement noise from the second angle measurement signal to generate the second estimated angle measurement signal.

Aspect 8: The beam scanning system of Aspect 5, wherein the system controller includes a noise attenuating filter programmed by the dynamic model, and wherein the noise attenuating filter is configured to output the first estimated angle measurement signal and the second estimated angle measurement signal.

Aspect 9: The beam scanning system of any of Aspects 1-8, wherein the driver system is configured to generate the first driving signal based on a difference between the first estimated angle measurement signal and a first setpoint control signal, and wherein the driver system is configured to generate the second driving signal based on a difference between the second estimated angle measurement signal and a second setpoint control signal.

Aspect 10: A beam scanning system, comprising: a two-dimensional scanner comprising a galvanometer scanner configured to rotate about a first scanning axis based on a first driving signal, and rotate about a second scanning axis based on a second driving signal; a time-of-flight sensor configured to receive a reflected light beam and generate a distance measurement based on the reflected light beam; a driver system configured to receive an angle vector setpoint corresponding to a two-dimensional scanning coordinate, drive the galvanometer scanner about the first scanning axis with the first driving signal based on the angle vector setpoint, and drive the galvanometer scanner about the second scanning axis with the second driving signal based on the angle vector setpoint; and a system controller configured with a dynamic model of the two-dimensional scanner, wherein the system controller is configured to generate a first estimated angle measurement signal based on the angle vector setpoint and the dynamic model, wherein the first estimated angle measurement signal follows a first angular trajectory of the galvanometer scanner about the first scanning axis, wherein the system controller is configured to generate a second estimated angle measurement signal based on the angle vector setpoint and the dynamic model, wherein the second estimated angle measurement signal follows a second angular trajectory of the galvanometer scanner about the second scanning axis, and wherein the system controller is configured to associate the distance measurement with a first estimated angle value corresponding to the first estimated angle measurement signal, associate the distance measurement with a second estimated angle value corresponding to the second estimated angle measurement signal, and generate a point in a three-dimensional point cloud based on the distance measurement, the first estimated angle value, and the second estimated angle value.

Aspect 11: The beam scanning system of Aspect 10, wherein the system controller is configured to apply the angle vector setpoint as an input to the dynamic model to obtain the first estimated angle value as a first output from the dynamic model and to obtain the second estimated angle value as a second output from the dynamic model.

Aspect 12: The beam scanning system of any of Aspects 10-11, wherein the system controller is configured to remove angle measurement noise based on the dynamic model to generate the first estimated angle measurement signal and the second estimated angle measurement signal.

Aspect 13: The beam scanning system of any of Aspects 10-12, wherein the system controller is configured to generate the first estimated angle measurement signal and the second estimated angle measurement signal substantially free of angle measurement noise based on the dynamic model.

Aspect 14: The beam scanning system of any of Aspects 10-13, further comprising: a first angle position detector configured to generate a first angle measurement signal based on detecting a first angular position of the galvanometer scanner about the first scanning axis; and a second angle position detector configured to generate a second angle measurement signal based on detecting a second angular position of the galvanometer scanner about the second scanning axis, wherein the system controller is configured to generate an estimated angle vector measurement signal based on the angle vector setpoint, an angle measurement vector signal, and the dynamic model, wherein the angle measurement vector signal represents a combination of the first angle measurement signal and the second angle measurement signal, and wherein the estimated angle vector measurement signal represents a combination of the first estimated angle measurement signal and the second estimated angle measurement signal.

Aspect 15: The beam scanning system of Aspect 14, wherein the system controller is configured to remove a first angle measurement noise component from the first angle measurement signal to generate the first estimated angle measurement signal based on applying the angle vector setpoint and the first angle measurement signal as first inputs to the dynamic model, and wherein the system controller is configured to remove a second angle measurement noise component from the second angle measurement signal to generate the second estimated angle measurement signal based on applying the angle vector setpoint and the second angle measurement signal as second inputs to the dynamic model.

Aspect 16: The beam scanning system of Aspect 14, wherein the system controller is configured to, based on receiving the angle vector setpoint as an input to the dynamic model, attenuate a first angle measurement noise from the first angle measurement signal to generate the first estimated angle measurement signal, and attenuate a second angle measurement noise from the second angle measurement signal to generate the second estimated angle measurement signal.

Aspect 17: The beam scanning system of Aspect 14, wherein the system controller includes a noise attenuating filter programmed by the dynamic model, and wherein the noise attenuating filter is configured to output the first estimated angle measurement signal and the second estimated angle measurement signal.

Aspect 18: The beam scanning system of any of Aspects 10-17, wherein the driver system is configured to compensate the first driving signal based on a difference between the first estimated angle measurement signal and a first setpoint control signal, and wherein the driver system is configured to compensate the second driving signal based on a difference between the second estimated angle measurement signal and a second setpoint control signal.

Aspect 19: The beam scanning system of any of Aspects 10-18, wherein the angle vector setpoint includes a first angle setpoint for the first scanning axis and a second angle setpoint for the second scanning axis.

Aspect 20: A beam scanning method, comprising: generating a first driving signal based on a first angle setpoint; generating a second driving signal based on a second angle setpoint; driving a two-dimensional scanner about a first scanning axis based on the first driving signal and about a second scanning axis based on the second driving signal; generating a distance measurement based on a reflected light beam; generating a first estimated angle measurement signal based on the first angle setpoint and a dynamic model of the two-dimensional scanner, wherein the first estimated angle measurement signal follows a first angular trajectory about the first scanning axis; generating a second estimated angle measurement signal based on the second angle setpoint and the dynamic model of the two-dimensional scanner, wherein the second estimated angle measurement signal follows a second angular trajectory about the second scanning axis; associating the distance measurement with a first estimated angle value corresponding to the first estimated angle measurement signal; associating the distance measurement with a second estimated angle value corresponding to the second estimated angle measurement signal; and generating a point in a three-dimensional point cloud based on the distance measurement, the first estimated angle value, and the second estimated angle value.

Aspect 21: A system configured to perform one or more operations recited in one or more of Aspects 1-20.

Aspect 22: An apparatus comprising means for performing one or more operations recited in one or more of Aspects 1-20.

Aspect 23: A non-transitory computer-readable medium storing a set of instructions, the set of instructions comprising one or more instructions that, when executed by a device, cause the device to perform one or more operations recited in one or more of Aspects 1-20.

Aspect 24: A computer program product comprising instructions or code for executing one or more operations recited in one or more of Aspects 1-20.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A beam scanning system, comprising:
a two-dimensional scanner comprising a first galvanometer scanner configured to rotate about a first scanning axis based on a first driving signal, and a second galvanometer scanner configured to rotate about a second scanning axis based on a second driving signal;
a time-of-flight sensor configured to receive a reflected light beam and generate a distance measurement based on the reflected light beam;
a driver system configured to receive a first angle setpoint for the first galvanometer scanner and a second angle setpoint for the second galvanometer scanner, drive the first galvanometer scanner with the first driving signal based on the first angle setpoint, and drive the second galvanometer scanner with the second driving signal based on the second angle setpoint; and
a system controller configured with a dynamic model of the two-dimensional scanner,
wherein the system controller is configured to generate a first estimated angle measurement signal based on the first angle setpoint and the dynamic model, wherein the first estimated angle measurement signal follows a first angular trajectory of the first galvanometer scanner about the first scanning axis,
wherein the system controller is configured to generate a second estimated angle measurement signal based on the second angle setpoint and the dynamic model, wherein the second estimated angle measurement signal follows a second angular trajectory of the second galvanometer scanner about the second scanning axis, and
wherein the system controller is configured to associate the distance measurement with a first estimated angle value corresponding to the first estimated angle measurement signal, associate the distance measurement with a second estimated angle value corresponding to the second estimated angle measurement signal, and generate a point in a three-dimensional point cloud based on the distance measurement, the first estimated angle value, and the second estimated angle value.

2. The beam scanning system of claim 1, wherein the system controller is configured to apply the first angle setpoint as a first input to the dynamic model to obtain the first estimated angle value as a first output from the dynamic model, and
wherein the system controller is configured to apply the second angle setpoint as a second input to the dynamic model to obtain the second estimated angle value as a second output from the dynamic model.

3. The beam scanning system of claim 1, wherein the system controller is configured to remove angle measurement noise based on the dynamic model to generate the first estimated angle measurement signal and the second estimated angle measurement signal.

4. The beam scanning system of claim 1, wherein the system controller is configured to generate the first estimated angle measurement signal and the second estimated angle measurement signal substantially free of angle measurement noise based on the dynamic model.

5. The beam scanning system of claim 1, further comprising:
a first angle position detector configured to generate a first angle measurement signal based on detecting a first angular position of the first galvanometer scanner about the first scanning axis; and
a second angle position detector configured to generate a second angle measurement signal based on detecting a second angular position of the second galvanometer scanner about the second scanning axis,
wherein the system controller is configured to generate the first estimated angle measurement signal based on the first angle setpoint, the first angle measurement signal, and the dynamic model, and
wherein the system controller is configured to generate the second estimated angle measurement signal based on the second angle setpoint, the second angle measurement signal, and the dynamic model.

6. The beam scanning system of claim 5, wherein the system controller is configured to remove a first angle measurement noise component from the first angle measurement signal to generate the first estimated angle measurement signal based on applying the first angle setpoint and the first angle measurement signal as first inputs to the dynamic model, and
wherein the system controller is configured to remove a second angle measurement noise component from the second angle measurement signal to generate the second estimated angle measurement signal based on applying the second angle setpoint and the second angle measurement signal as second inputs to the dynamic model.

7. The beam scanning system of claim 5, wherein the system controller is configured to, based on receiving the first angle setpoint as a first input to the dynamic model, attenuate a first angle measurement noise from the first angle measurement signal to generate the first estimated angle measurement signal, and
wherein the system controller is configured to, based on receiving the second angle setpoint as a second input to the dynamic model, attenuate a second angle measurement noise from the second angle measurement signal to generate the second estimated angle measurement signal.

8. The beam scanning system of claim 5, wherein the system controller includes a noise attenuating filter programmed by the dynamic model, and
wherein the noise attenuating filter is configured to output the first estimated angle measurement signal and the second estimated angle measurement signal.

9. The beam scanning system of claim 1, wherein the driver system is configured to generate the first driving signal based on a difference between the first estimated angle measurement signal and a first setpoint control signal, and
wherein the driver system is configured to generate the second driving signal based on a difference between the second estimated angle measurement signal and a second setpoint control signal.

10. A beam scanning system, comprising:
a two-dimensional scanner comprising a galvanometer scanner configured to rotate about a first scanning axis based on a first driving signal, and rotate about a second scanning axis based on a second driving signal;
a time-of-flight sensor configured to receive a reflected light beam and generate a distance measurement based on the reflected light beam;
a driver system configured to receive an angle vector setpoint corresponding to a two-dimensional scanning coordinate, drive the galvanometer scanner about the first scanning axis with the first driving signal based on the angle vector setpoint, and drive the galvanometer scanner about the second scanning axis with the second driving signal based on the angle vector setpoint; and
a system controller configured with a dynamic model of the two-dimensional scanner,
wherein the system controller is configured to generate a first estimated angle measurement signal based on the angle vector setpoint and the dynamic model, wherein the first estimated angle measurement signal follows a first angular trajectory of the galvanometer scanner about the first scanning axis,
wherein the system controller is configured to generate a second estimated angle measurement signal based on the angle vector setpoint and the dynamic model, wherein the second estimated angle measurement signal follows a second angular trajectory of the galvanometer scanner about the second scanning axis, and
wherein the system controller is configured to associate the distance measurement with a first estimated angle value corresponding to the first estimated angle measurement signal, associate the distance measurement with a second estimated angle value corresponding to the second estimated angle measurement signal, and generate a point in a three-dimensional point cloud based on the distance measurement, the first estimated angle value, and the second estimated angle value.

11. The beam scanning system of claim 10, wherein the system controller is configured to apply the angle vector setpoint as an input to the dynamic model to obtain the first estimated angle value as a first output from the dynamic model and to obtain the second estimated angle value as a second output from the dynamic model.

12. The beam scanning system of claim 10, wherein the system controller is configured to remove angle measurement noise based on the dynamic model to generate the first estimated angle measurement signal and the second estimated angle measurement signal.

13. The beam scanning system of claim 10, wherein the system controller is configured to generate the first estimated angle measurement signal and the second estimated angle measurement signal substantially free of angle measurement noise based on the dynamic model.

14. The beam scanning system of claim 10, further comprising:
a first angle position detector configured to generate a first angle measurement signal based on detecting a first angular position of the galvanometer scanner about the first scanning axis; and
a second angle position detector configured to generate a second angle measurement signal based on detecting a second angular position of the galvanometer scanner about the second scanning axis,
wherein the system controller is configured to generate an estimated angle vector measurement signal based on the angle vector setpoint, an angle measurement vector signal, and the dynamic model,
wherein the angle measurement vector signal represents a combination of the first angle measurement signal and the second angle measurement signal, and
wherein the estimated angle vector measurement signal represents a combination of the first estimated angle measurement signal and the second estimated angle measurement signal.

15. The beam scanning system of claim 14, wherein the system controller is configured to remove a first angle measurement noise component from the first angle measurement signal to generate the first estimated angle measurement signal based on applying the angle vector setpoint and the first angle measurement signal as first inputs to the dynamic model, and
wherein the system controller is configured to remove a second angle measurement noise component from the second angle measurement signal to generate the second estimated angle measurement signal based on applying the angle vector setpoint and the second angle measurement signal as second inputs to the dynamic model.

16. The beam scanning system of claim 14, wherein the system controller is configured to, based on receiving the angle vector setpoint as an input to the dynamic model, attenuate a first angle measurement noise from the first angle measurement signal to generate the first estimated angle measurement signal, and attenuate a second angle measurement noise from the second angle measurement signal to generate the second estimated angle measurement signal.

17. The beam scanning system of claim 14, wherein the system controller includes a noise attenuating filter programmed by the dynamic model, and
wherein the noise attenuating filter is configured to output the first estimated angle measurement signal and the second estimated angle measurement signal.

18. The beam scanning system of claim 10, wherein the driver system is configured to compensate the first driving signal based on a difference between the first estimated angle measurement signal and a first setpoint control signal, and
wherein the driver system is configured to compensate the second driving signal based on a difference between the second estimated angle measurement signal and a second setpoint control signal.

19. The beam scanning system of claim 10, wherein the angle vector setpoint includes a first angle setpoint for the first scanning axis and a second angle setpoint for the second scanning axis.

20. A beam scanning method, comprising:
generating a first driving signal based on a first angle setpoint;
generating a second driving signal based on a second angle setpoint;
driving a two-dimensional scanner about a first scanning axis based on the first driving signal and about a second scanning axis based on the second driving signal;
generating a distance measurement based on a reflected light beam;
generating a first estimated angle measurement signal based on the first angle setpoint and a dynamic model of the two-dimensional scanner, wherein the first estimated angle measurement signal follows a first angular trajectory about the first scanning axis;
generating a second estimated angle measurement signal based on the second angle setpoint and the dynamic model of the two-dimensional scanner, wherein the second estimated angle measurement signal follows a second angular trajectory about the second scanning axis;
associating the distance measurement with a first estimated angle value corresponding to the first estimated angle measurement signal;
associating the distance measurement with a second estimated angle value corresponding to the second estimated angle measurement signal; and
generating a point in a three-dimensional point cloud based on the distance measurement, the first estimated angle value, and the second estimated angle value.
